(19) United States
(12) Patent Application Publication
(10) Pub. No.: US 2004/0206315 A1
(43) Pub. Date: Oct. 21, 2004

(54) System for the construction of pumps, compressor, and motor engines, formed by a rotary chamber and pistons which are driven in the same direction at varying velocities alternatively opposite to each other, inside a fixed open or closed structure

(76) Inventor: Hugo Julio Kopelowicz, Rio de Janeiro (BR)

Correspondence Address: HARNESS, DICKEY & PIERCE, P.L.C., P.O. BOX 828, BLOOMFIELD HILLS, MI, 48303, US

(21) Appl. No.: 10/486,323

(22) PCT Filed: Aug. 8, 2002
(86) PCT No.: PCT/BR02/00111

(30) Foreign Application Priority Data
Aug. 9, 2001 (BR) PI 0103272

(51) Int. Cl. F02B 53/00; F04B 27/06

(52) U.S. Cl. 123/45 R; 417/461

(57) ABSTRACT

The present invention refers to a system for the construction of pumps, compressors and motor engines, consisting of a rotary chamber and pistons which are driven in the same direction at varying velocities alternatively opposite to each other, through an adequate mechanism of alternatively opposite variation of velocities inside a fixed open or closed structure. The new system is characterized by the chamber not being fundamentally fixed. On the contrary, it is rotative, preferably formed by two rotary half-chambers, which at least have a displacer or a piston each, jointed to each one of them, closing its own half-chamber and penetrating by sliding in the hollow of the other half-chamber, creating at least two compartments that alternatively vary their volume. The axes of each rotary half-chamber move inside a fixed structure that supports them. This structure may be open or contain a hermetically closed department. In one of its versions, the structure bears a ring, where the openings for the intake and outlet of fluids are located. Placed against the sides opposite to this ring, runs each rotary half-chamber, closing the main chamber. At least one piston or displacer fixed to each half-chamber seals up a sector of the same and introduces itself in a sliding way in the other rotary half-chamber, dividing the chamber into at least two compartments. When these are set in motion by an adequate mechanism (sliding arms, eccentric gears, elliptic, planetary gears, etc.), they alternatively vary their volume.

### SCOPE OF THE INVENTION

The present invention refers to a system for the construction of pumps, compressors and motor engines, consisting of rotary chambers and pistons that are driven in the same direction at varying velocities alternatively opposite to each other, through an adequate mechanism of alternatively opposite variation of velocities, inside a fixed open or closed structure.

The new system is characterized by the fact that the chamber is not fundamentally fixed. On the contrary, it is rotative, formed by two rotary half-chambers, with at least one displacer or piston each, jointed to each one of them, closing its own half-chamber and penetrating respectively by sliding in the hollow of the other half-chamber, creating at least two compartments that alternatively vary their volume.

The axes of each rotary half-chamber rotate inside a fixed structure that supports them. This structure may be open or contain a hermetically closed, airtight compartment, working like a sort of crankcase.

In one of its versions, the structure bears a ring where the openings for the intake and outlet of fluids are located. Leaning against the lateral sides opposite to this ring, run each rotary half-chamber, closing the main chamber. At least one piston fixed to each half-chamber seals up a sector of the same and slides itself into the other rotary half-chamber, dividing the chamber into at least two compartments. When the rotary half-chambers are set in motion by an adequate mechanism of alternatively opposite velocities (sliding arms, eccentric gears, elliptics, cone with planetary gears, etc.), they alternatively vary the volumes of the half-chambers' compartments.

In another version, the two half-chambers work totally placed against each other, and each of them has, preferably near the displacer, an opening serving for the intake and outlet of fluids. A ring on the fixed structure, external to the rotary half-chambers, properly sealed up, which bears intake and outlet openings, alternatively closes and opens the intake and outlet of fluids, as the openings of the half-chambers slide along it.

In a third realization, one of the rotary half-chambers makes up the central body and one of the sides of the main chamber, and the other rotary half-chamber forms the external part and the other side of the chamber.

The structure inside which the two half chambers work may be open, allowing for the free circulation of air, or else hermetically closed, harboring a hollow inside which lubricating and/or refrigerating (etc.) fluids can be placed, at variable pressures.

Using this new system, it is possible to build compression or suction pumps, or otherwise pumps that operate on the motion of fluids or gases, internal combustion engines or motors run by the internal heating or cooling of fluids, or are driven by fluid pressure, etc.

### THE INVENTION AND THE STATE-OF-THE-ART

Systems of compressors or engines that operate with two rotors, with at least one piston each, are already well-known. The two rotors operate inside a fixed chamber, dividing it into at least two compartments that vary in volume by means of some kind of special mechanism (sliding arms, eccentric gears, elliptics, or planetary gears, etc.), that drives them at alternatively opposite variable velocities.

These systems present important problems in the areas of sealing up, heating and friction, when compared with the alternative or eccentric rotating systems. It is these problems that have prevented their commercialization to date.

The models known to the present are based on the principle that when two rotors are set in motion inside a fixed chamber, a segment of these rotors carries a displacer or piston that operates closing the chamber and dividing it into at least two compartments. In some models, the displacer also operates partly over the body of the other rotor. The present invention proposes a rotary chamber made up of two rotary half-chambers, and its purpose is to provide a new form of construction that in several fundamental fields goes beyond the known models or systems for the construction of engines or rotative compressors known to date, based on the principle of the alternate variation of velocity of the two rotors.

The advantages of the present invention are clearly expressed on the following fundamental items:

1) Sealing up: decreasing the size of the areas to be sealed up, since each rotary half-chamber has a fixed sealing up of its hollow, and the displacer or piston only operates sliding over the other half-chamber, which reduces by up to 50% the areas to be sealed up.

2) Friction: decreasing friction, not only on account of the lesser areas to be sealed up, but also because the areas of the other half-chamber where the displacer moves in a sliding way are in a relative motion in the same direction. For instance, when one of the rotors turns in a circular arc of 90°, the other turns in the same direction in an arc of 270°, the relative movement between the two rotors being 180°. If this same movement were realized in relation to a fixed chamber, we would have a sum of the movements equivalent to a 360° arc.

3) Heating: to this day, the known models carried out the operations of compression, or explosion, that generate heat only on one side of the chamber and those that lower the temperature on the other side (suction and exhaustion). This fact causes an unbalanced dilation that jeopardizes the sealing and increases friction.

The present invention, not having a fixed chamber inside which the rotors with their respective pistons operate, alternates the different parts of the chamber, those that receive heat and those that are cooled, homogenizing continuously and entirely the temperature of the half-chambers, thus preventing a thermal deformation of the same. On the other hand, if the half-chambers rotate within a fixed structure properly sealed up with some sort of refrigerating fluid, this would help to homogenize temperature even more.

Besides these three critical advantages of the present invention, that render possible to utilize the principle of rotors moving at various and alternatively opposite velocities in the construction of equipment without the deficiencies that made it impossible, to this day, that the systems displayed advantages as compared to the systems of alternative or eccentric rotating pistons. Further advantages will be pointed out in the areas of refrigeration, lubrication and sealing up of the whole set and in its construction.

The fixed structure inside which the half-chambers move can be easily sealed up and a cooling liquid can be placed inside it.

It is also possible to put a lubricating fluid inside. It can flow through appropriate ducts driven into the half-chambers by centrifugal force or by pressure right to the pistons.

Otherwise, the lubricating liquid can be cooled to maintain the ideal operating temperature.

The sealing up of the structure where the rotors run allows for the creation of a compartment where it is possible to increase pressure, making the sealing between the chambers easier by means of the fixed ring, as well as between the half-chambers, insulating the apparatus from the environment in which it works.

Another advantage presented by the use of the rotary half-chambers is that, as the size of the sliding part of the pistons is reduced by up to 50%, it becomes possible to build longer engines or compressors, consequently with a smaller diameter, and this will bring down the vibrations caused by centrifugal force, allowing for the operation at higher velocities with lower vibrations.

### BRIEF DESCRIPTION OF THE DRAWINGS

The present invention is illustrated by the attached drawings, where:

FIG. 1 is a top view of a compressor formed by two half-chambers rotating within a fixed structure, each of them having an axis with its respective arms that are set in motion by a connecting rod system with sliding bearings.

FIG. 2 is a top view of a compressor formed by two half-chambers that operate placed against each other.

FIG. 3 is a lateral view of the same model that illustrates FIG. 2.

FIG. 4 is a top view of a compressor formed by two rotary half-chambers; one of them makes up one of the sides and the internal part of the chamber, and the other rotary half-chamber makes up the remaining side and the external part of the chamber.

### BRIEF DESCRIPTION OF THE FUNCTIONING, BASED ON THE DRAWINGS

With the purpose of exemplifying and without hindering or limiting the present invention, the same will be described in relation to the above mentioned drawings.

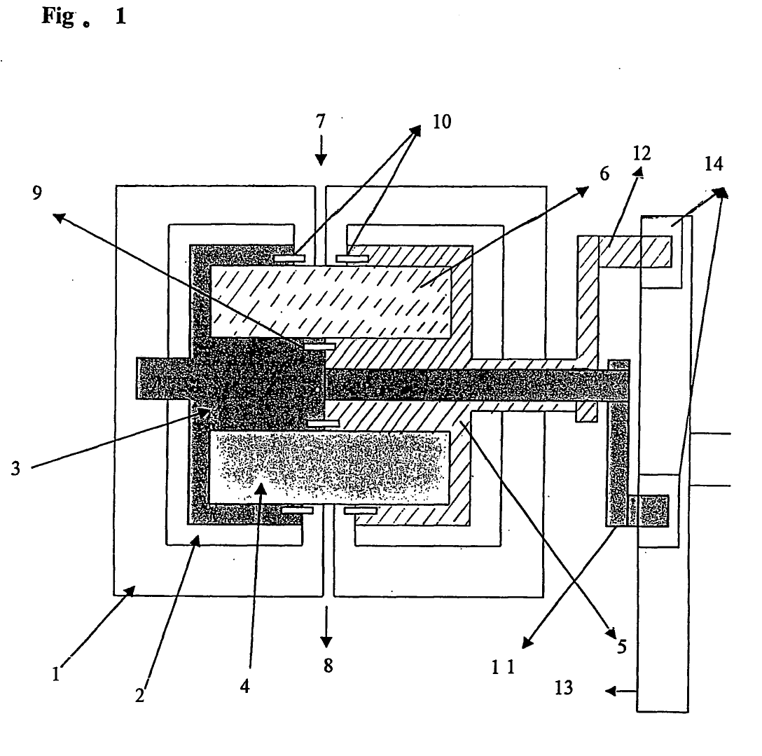

Thus, in FIG. 1 is shown a top view of a compressor formed by two rotary half-chambers 3 and 5, each one of them displaying a piston 4 and 6, that penetrates by sliding into the other half-chamber. Half-chambers 3 and 5 rotate inside a fixed structure 1 with a hollow 2 that can contain a lubricating and/or cooling fluid. Structure 1 exhibits a kind of ring 15 with two openings for intake and letting out, 7 and 8, against which the two half-chambers 3 and 5 are laterally placed, with their respective seals 10, and seal 9 that works between the two half-chambers 3 and 5. Each half-chamber has an axis with its respective arms 11 and 12, that are set in motion by a double connecting rod system 13, coupled to an engine. The center of the double connecting rod axis is distant from the center of the axis of the motion transmitter arms 11 and 12, which accounts for the displacement of the sliding bearings 14, varying the length of the radius of motion transmission, changing a constant velocity motion into a motion of varied alternatively opposite velocity between both rotary half-chambers. Rotating this way, the compartments created between the two pistons alternatively increase and decrease their volume, allowing for the operations of suction and compression. In their displacement, the pistons open or close openings 7 and 8 of ring 15, permitting intake and outlet of fluids. At each 360° turn of the motor connecting rod will correspond two suction operations and two compression operations of the present rotative compressor.

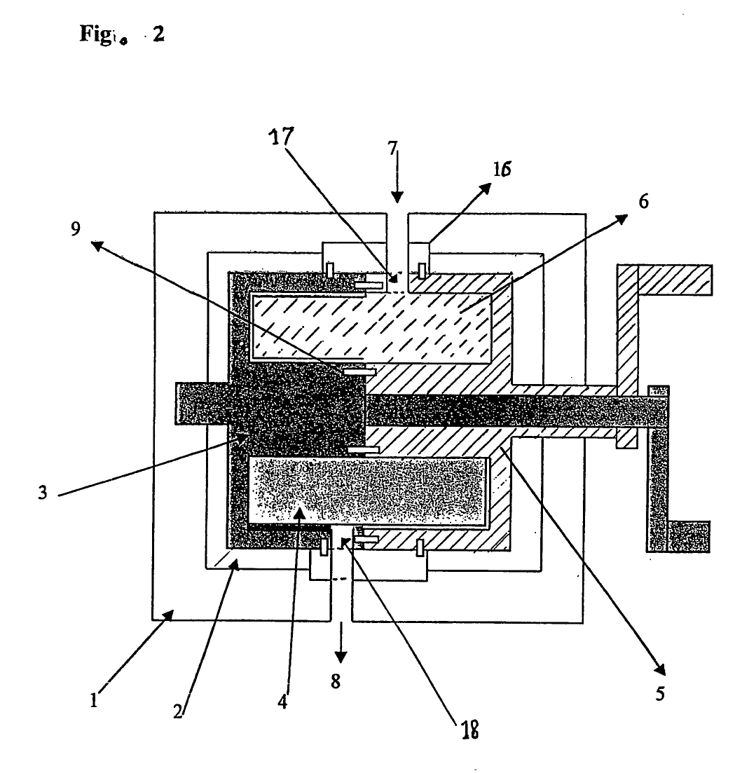

FIG. 2 is a top view of a compressor formed by two half-chambers that operate placed against each other and have an opening each, 17 and 18. A ring 16 external to both half-chambers, that is part of fixed structure 1, allows for the intake and letting out of fluids when the openings of each half-chamber in their displacement coincide with openings 7 and 8 of ring 16.

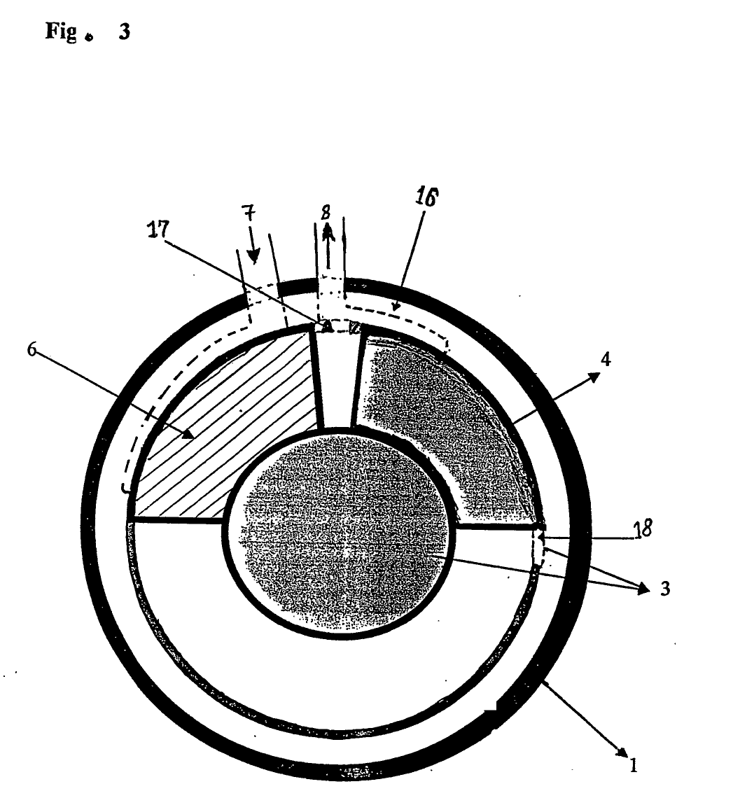

FIG. 3 is a lateral view of the same model illustrating FIG. 2.

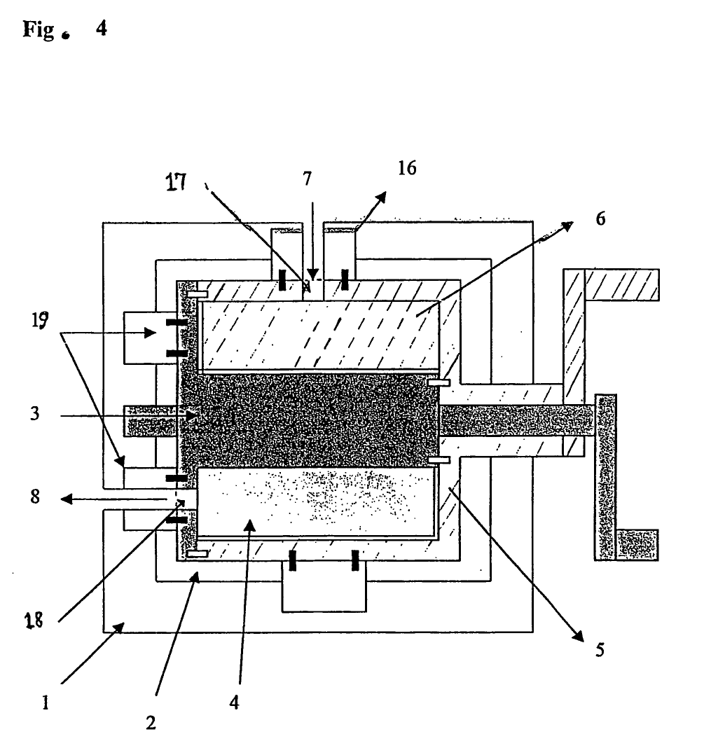

FIG. 4 is a top view of a compressor formed by two rotary half-chambers; one of them, 3, makes up one of the sides and the inside of the main chamber, and the other one, 5, the remaining side and the outside part of the chamber. The seals for intake and outlet are operated through ring 16 for the rotary half-chamber 5 and through ring 19 for rotary half-chamber 3.

1. A system for the construction of pumps, compressors and motor engines, formed by a rotary chamber and pistons that move in the same direction at varying and alternatively opposite velocities to each other inside a fixed open or closed structure, characterized by the fact that the chamber is not fundamentally fixed. On the contrary, it is rotatively formed by two rotary half-chambers, which at least have a piston jointed to each one of them, closing its own half-chamber and penetrating respectively by sliding into the hollow of the other half-chamber, so as to create at least two compartments that alternatively vary their volume when they are driven by a mechanism of alternatively opposite variation of velocities (sliding aims, eccentric gears, elliptics, planetary gears, etc.).

2. A system m accordance with claim 1, characterized by the fact that the axes in each rotary half-chamber rotate inside a fixed structure that supports them, and the structure can either be open or contain a hermetically closed hollow.

3. A system in accordance with claim 1, characterized by the fact that the fixed structure bears a ring where the openings for intake and outlet of fluids are located. Placed against the lateral sides of this ring, works each rotary half-chamber with its respective seals closing up the chamber.

4. A system in accordance with claim 1, characterized by the fact that both rotary half-chambers work totally placed against each other, and they each have an opening serving for the intake and outlet of fluids.

5. A system in accordance with any claim 1, characterized by the fact that the fixed structure bears a ring with openings for the intake and outlet of fluids that is placed against the external part of each rotary half-chamber, alternately closing and opening the openings of the same.

6. A system in accordance with claim 1, characterized by the fact that one of the rotary half-chambers makes up the internal wall and one of the sides of the main chamber, and the other rotary half-chamber makes up the external wall and the other side of the chamber.

7. A system in accordance with claim 1, characterized by the fact that the rotary chamber is made up of two parts, preferably in the form of rotary half-chambers, and the main chamber can have the most diverse geometrical forms.

8. A system in accordance with claim 1, characterized by the fact that each rotary half-chamber has two or more pistons and openings.

9. A system in accordance with claim 1, characterized by the fact that it is used for the construction of pumps, fluid compressors, internal combustion engines, or hydraulic driven engines, or engines driven by pressure or by the heating and cooling of fluids, etc.
